(19) United States
(12) Patent Application Publication
(10) Pub. No.: US 2024/0145880 A1
(43) Pub. Date: May 2, 2024

(54) FLEXIBLE BATTERY AND ELECTRONIC DEVICE COMPRISING SAME

(71) Applicant: Samsung Electronics Co., Ltd., Suwon-si (KR)

(72) Inventors: Seonyoung PARK, Suwon-si (KR); Yeonil LEE, Suwon-si (KR); Jaeman CHOI, Suwon-si (KR)

(21) Appl. No.: 18/530,858

(22) Filed: Dec. 6, 2023

Related U.S. Application Data
(63) Continuation of application No. PCT/KR2022/007769, filed on May 31, 2022.

(30) Foreign Application Priority Data
Jun. 10, 2021 (KR) 10-2021-0075567

(51) Int. Cl. H01M 50/54; H01M 50/105; H01M 50/466; H01M 50/536

(52) U.S. Cl. CPC H01M 50/54; H01M 50/105; H01M 50/536; H01M 50/466; H01M 2220/30

(57) ABSTRACT

A flexible battery and an electronic device comprising same are provided. The flexible battery includes a battery assembly including a plurality of positive electrode plates and a plurality of negative electrode plates alternately stacked with each other and a separator arranged in between the positive electrode plates and the negative electrode plates, and a main positive electrode tab, a main negative electrode tab, an auxiliary positive electrode tab, and an auxiliary negative electrode tab which are attached to each of the plurality of positive electrode plates and protrude in a first direction of the battery assembly, wherein the separator may include a first portion arranged in between the positive electrode plates and the negative electrode plates and a second portion which extends from the first portion in the first direction and is arranged in between the auxiliary positive electrode tab and the auxiliary negative electrode tab.

### CROSS-REFERENCE TO RELATED APPLICATION(S)

This application is a continuation application, claiming priority under § 365(c), of an International application No. PCT/KR2022/007769, filed on May 31, 2022, which is based on and claims the benefit of a Korean patent application number 10-2021-0075567, filed on Jun. 10, 2021, in the Korean Intellectual Property Office, the disclosure of which is incorporated by reference herein in its entirety.

### BACKGROUND

### 1. Field

The disclosure relates to a flexible battery and an electronic device comprising the same.

### 2. Description of Related Art

An electronic device may perform various functions (e.g., an execution of an application) using power from a battery.

The electronic device may charge a battery using either wired or wireless charging methods. For example, the electronic device, when wired to a power supply device (e.g., a travel adapter (TA)), may charge the battery using power supplied by the power supply device (e.g., a travel adapter (TA)). In another example, the electronic device may charge a battery using power supplied wirelessly from a wireless charging device (e.g., a wireless charging pad) when the electronic device is positioned within a specified distance from a wireless charging coil of the wireless charging device.

The above information is presented as background information only to assist with an understanding of the disclosure. No determination has been made, and no assertion is made, as to whether any of the above might be applicable as prior art with regard to the disclosure.

### SUMMARY

An electronic device is being developed in a variety of form factors that may modify a shape of a housing. In an example, electronic device manufacturers are conducting research and development on various form factors that allow the housing to be folded or unfolded, or portions of the housing to slidingly move. Electronics in these form factors may vary a display area or shape of the display based on the shape of the housing.

Meanwhile, as the electronic devices are being developed in a variety of form factors that allow the shape of the housing to change, there is increasing interest in a flexible battery that may be bent or folded. The flexible battery may be applied to the electronic devices in a variety of form factors where the shape of the housing changes since the flexible battery may be bent or folded.

There may be a problem in that an electrode portion, for example, a positive electrode tab or a negative electrode tab inside the battery, is disconnected due to repeated bending of the flexible battery. For example, when the positive electrode tab or the negative electrode tab is disconnected in the flexible battery, poor charging may occur.

Aspects of the disclosure are to address at least the above-mentioned problems and/or disadvantages and to provide at least the advantages described below. Accordingly, an aspect of the disclosure is to provide a flexible battery and an electronic device including the same with a robust design structure that is resistant to repeated bending.

Additional aspects will be set forth in part in the description which follows and, in part, will be apparent from the description, or may be learned by practice of the presented embodiments.

In accordance with an aspect of the disclosure, a flexible battery is provided. The flexible battery includes a pouch, a battery assembly disposed inside the pouch, the battery assembly comprising a plurality of positive electrode plates and a plurality of negative electrode plates stacked alternately with each other, and a separator disposed in between the positive electrode plates and the negative electrode plates, a main positive electrode tab attached to each of the plurality of positive electrode plates and protruding in a first direction of the battery assembly, a main negative electrode tab attached to each of the plurality of negative electrode plates and protruding in the first direction of the battery assembly, an auxiliary positive electrode tab attached to each of the plurality of positive electrode plates, protruding in the first direction of the battery assembly, and disposed in between the main positive electrode tab and the main negative electrode tab, and an auxiliary negative electrode tab attached to each of the plurality of negative electrode plates, protruding in the first direction of the battery assembly, and disposed in between the main positive electrode tab and the main negative electrode tab, in which the separator includes a first portion disposed in between the positive electrode plates and the negative electrode plates, and a second portion extending in the first direction from the first portion, and disposed in between the auxiliary positive electrode tab and the auxiliary negative electrode tab so as to overlap at least a portion of the auxiliary positive electrode tab and at least a portion of the auxiliary negative electrode tab.

In accordance with another aspect of the disclosure, an electronic device is provided. The electronic device includes a housing, and a flexible battery disposed inside the housing, in which the flexible battery includes a pouch, a battery assembly disposed inside the pouch, the battery assembly comprising a plurality of positive electrode plates and a plurality of negative electrode plates stacked alternately with each other, and a separator disposed in between the positive electrode plates and the negative electrode plates, a main positive electrode tab attached to each of the plurality of positive electrode plates and protruding in a first direction of the battery assembly, a main negative electrode tab attached to each of the plurality of negative electrode plates and protruding in the first direction of the battery assembly, an auxiliary positive electrode tab attached to each of the plurality of positive electrode plates, protruding in the first direction of the battery assembly, and disposed in between the main positive electrode tab and the main negative electrode tab, and an auxiliary negative electrode tab attached to each of the plurality of negative electrode plates, protruding in the first direction of the battery assembly, and disposed in between the main positive electrode tab and the main negative electrode tab, and in which the separator includes a first portion disposed in between the positive electrode plates and the negative electrode plates, and a second portion extending in the first direction from the first portion, and disposed in between the auxiliary positive electrode tab and the auxiliary negative electrode tab so as to overlap at least a portion of the auxiliary positive electrode tab and at least a portion of the auxiliary negative electrode tab.

A flexible battery and an electronic device including the same, according to various embodiments of the disclosure, can have improved reliability by having a robust design structure that reduces damage to an electrode portion of the battery even with repeated bending.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a schematic perspective view of a battery according to an embodiment of the disclosure;

FIG. 3 is an exploded perspective view of a battery according to an embodiment of the disclosure;

FIG. 4 is a perspective view schematically illustrating a battery assembly according to an embodiment of the disclosure;

FIG. 5 is a stacked perspective view schematically illustrating a method of stacking a battery assembly according to an embodiment of the disclosure;

FIG. 6 is a top plan view schematically illustrating structures of a positive electrode assembly, a separator, and a negative electrode assembly, according to an embodiment of the disclosure;

FIG. 7 is a top plan view illustrating a state in which a positive electrode assembly, separator, and negative electrode assembly are stacked, according to an embodiment of the disclosure;

FIG. 8 is a cross-sectional view illustrating a structure of an auxiliary positive electrode tab, an auxiliary negative electrode tab, and a second portion of a separator according to lines 8-8 illustrated in FIG. 7 according to an embodiment of the disclosure;

FIG. 9A is a view illustrating a state before proceeding with a process for connecting a positive electrode tab and connecting a negative electrode tab according to an embodiment of the disclosure; and

FIG. 9B is a view illustrating a state before proceeding with a process for connecting a positive electrode tab and connecting a negative electrode tab according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

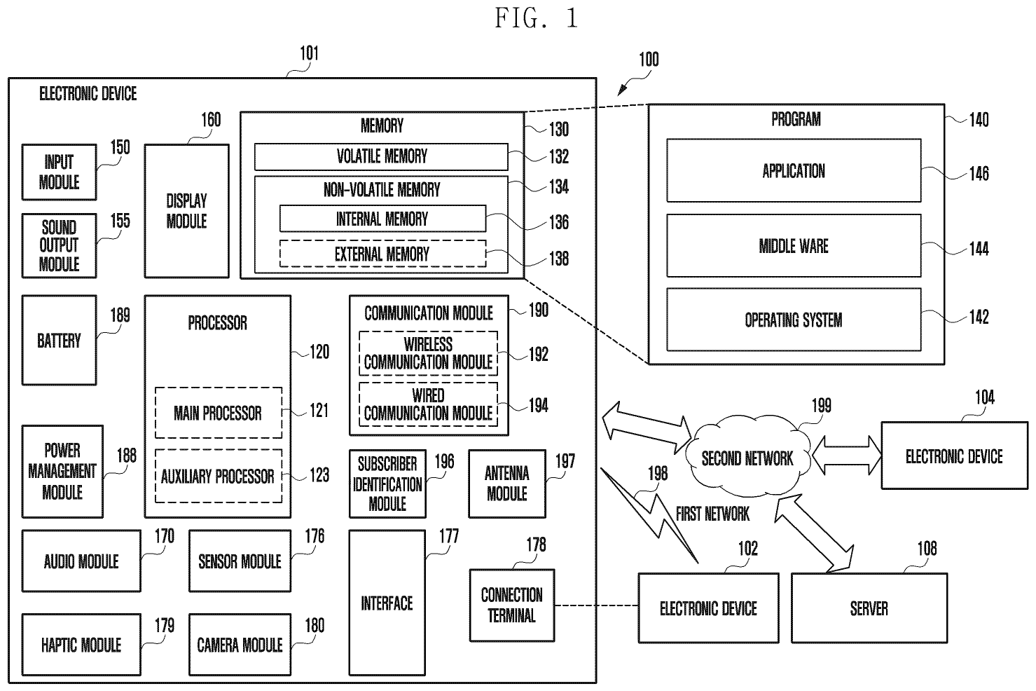

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to one embodiment, the electronic device 101 may communicate with the electronic device 104 via the server 108. According to another embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may be configured to execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to another embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, a communication processor (CP), and the like) that is operable independently from, or in conjunction with, the main processor 121. In an example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to one embodiment, the auxiliary processor 123 (e.g., an image signal processor or a communication processor) may be implemented as part of another component (e.g., the camera module 180 or the communication module 190) functionally related to the auxiliary processor 123. According to another embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, reinforcement learning, and the like. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may be configured to store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may, for example, receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may, for example, output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may be configured to visually provide information to the outside (e.g., a user) of the electronic device 101. The display module 160 may include, for example, a display, a hologram device, or a projector and control circuitry to control a corresponding one of the display, hologram device, and projector. In an embodiment, the display module 160 may include a touch sensor adapted to detect a touch, or a pressure sensor adapted to measure the intensity of force incurred by the touch.

The audio module 170 may convert a sound into an electrical signal and vice versa. In another embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to one embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, an illuminance sensor, and the like.

The interface 177 may, for example, support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). In an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to another embodiment, the haptic module 179 may include, for example, a motor, a piezoelectric element, or an electric stimulator.

The camera module 180 may capture a still image or moving images. According to another embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to one embodiment, the battery 189 may include, for example, a primary cell which is not rechargeable, a secondary cell which is rechargeable, or a fuel cell.

The communication module 190 may be configured to support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. In an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may, for example, identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may, for example, support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to another embodiment, the antenna module 197 may include an antenna including a radiating element composed of a conductive material or a conductive pattern formed in or on a substrate (e.g., a printed circuit board (PCB)). According to yet another embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to still another embodiment, another component (e.g., a radio frequency integrated circuit (RFIC)) other than the radiating element may be additionally formed as part of the antenna module 197.

According to some embodiments, the antenna module 197 may form a mmWave antenna module. According to one embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to another embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may, for example, provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to yet another embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to one embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. In an example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). In an example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory”simply means that the storage medium is a tangible device, and does not include a signal (e.g., an electromagnetic wave), but this term does not differentiate between where data is semi-permanently stored in the storage medium and where the data is temporarily stored in the storage medium.

In an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to some embodiments, each component (e.g., a module or a program) of the above-described components may include a single entity or multiple entities, and some of the multiple entities may be separately disposed in different components. According to other embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

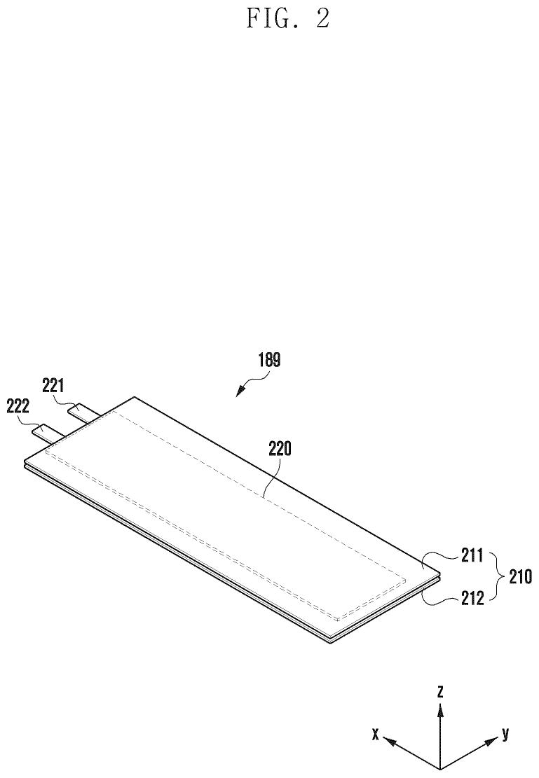

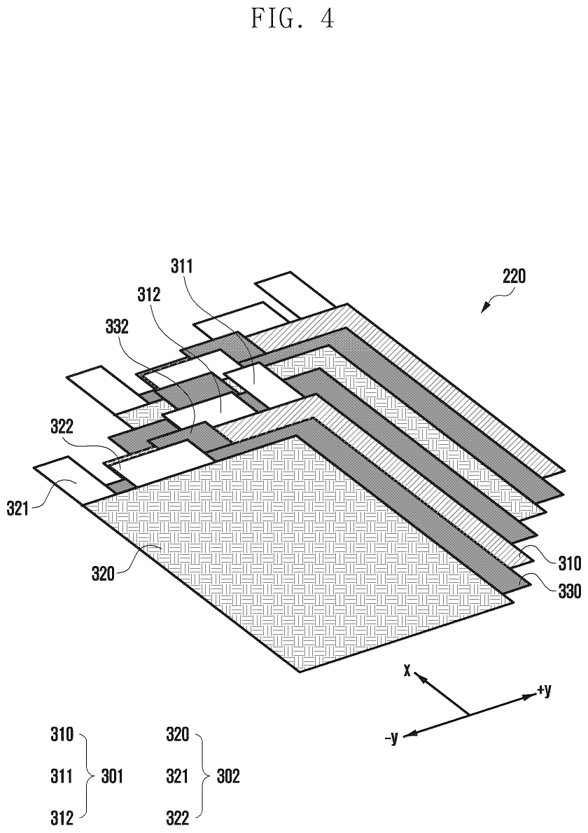

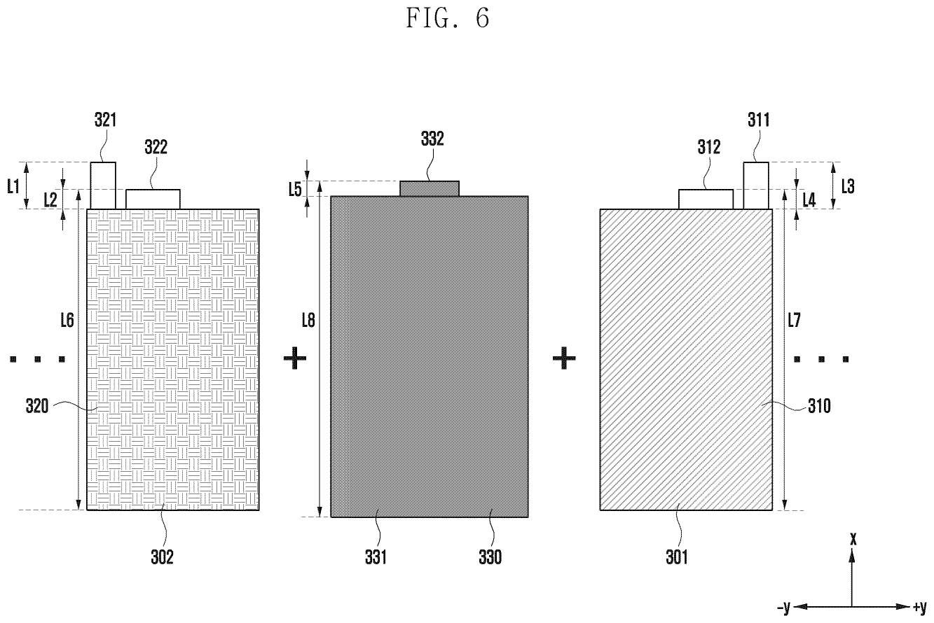

A flexible battery (e.g., a battery 189 in FIG. 1), according to some embodiments, may include a pouch (e.g., a pouch 210 in FIG. 2), a battery assembly (e.g., a battery assembly 220 in FIG. 2) disposed inside the pouch 210, the battery assembly 220 including a plurality of positive electrode plates (e.g., a positive electrode plate 310 in FIG. 4) and a plurality of negative electrode plates (e.g., a negative electrode plate 320 in FIG. 4) alternately stacked with each other, and a separator (e.g., a separator 330 in FIG. 4) disposed, for example, between the positive electrode plates 310 and the negative electrode plates 320, a main positive electrode tab (e.g., a main positive electrode tab 311 in FIG. 4) attached to each of the plurality of positive electrode plates 310 and protruding in a first direction of the battery assembly 220, a main negative electrode tab (e.g., a main negative electrode tab 321 in FIG. 4) attached to each of the plurality of negative electrode plates 320 and protruding in the first direction of the battery assembly 220, an auxiliary positive electrode tab (e.g., an auxiliary positive electrode tab 311 in FIG. 4) attached to each of the plurality of positive electrode plates 310 and protruding in the first direction of the battery assembly 220, and disposed, for example, between the main positive electrode tab 311 and the main negative electrode tab 321; and an auxiliary negative electrode tab (e.g., an auxiliary negative electrode tab 312 in FIG. 4) attached to each of the plurality of negative electrode plates 320, protruding in the first direction of the battery assembly 220, and disposed between the main positive electrode tab 311 and the main negative electrode tab 321, in which the separator 330 may include a first portion (e.g., a first portion 331 in FIG. 6) disposed, for example, between the positive electrode plate 310 and the negative electrode plate 320, and a second portion (e.g., a second portion 332 in FIG. 6) extending from that first portion 331 in the first direction and disposed between the auxiliary positive electrode tabs 312 and the auxiliary negative electrode tabs 322 so as to overlap at least a portion of the auxiliary positive electrode tab 312 and at least a portion of the auxiliary negative electrode tab 322.

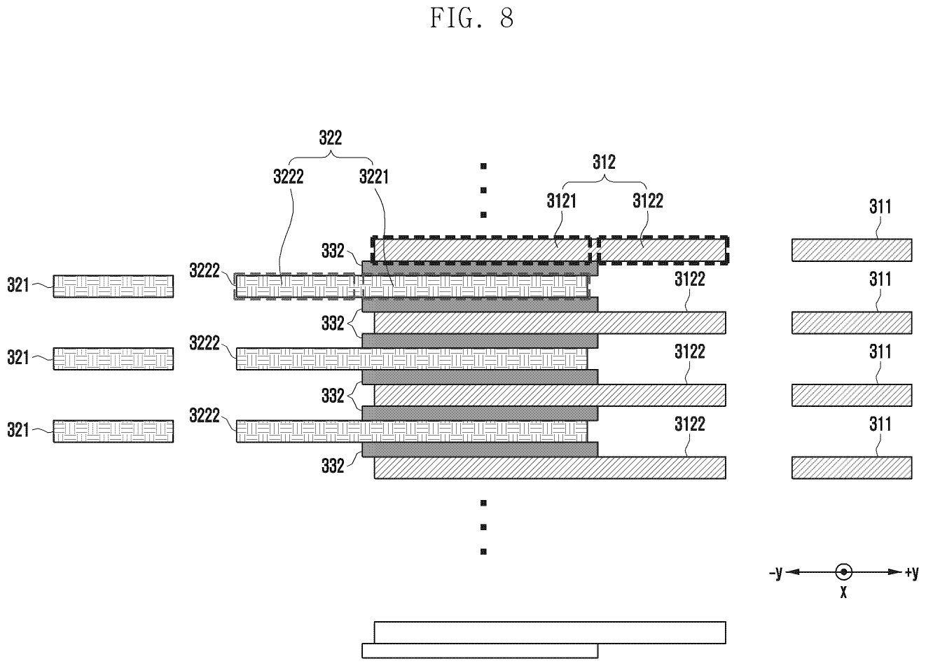

In an embodiment, the auxiliary positive electrode tab 312 may include a first overlap area (e.g., a first overlap area 3121 in FIG. 8) disposed to overlap the second portion 332 of the separator 330 and at least a portion of the auxiliary negative electrode tab 322, and a first binding area (e.g., a first binding area 3122 in FIG. 8) extending from the first overlap area 3121 in a second direction perpendicular to the first direction and not overlapping the second portion 332 of the separator 330 and the at least a portion of the auxiliary negative electrode tab 322.

According to another embodiment, the auxiliary negative electrode tab 322 may include a second overlap area (e.g., a second overlap area 3221 in FIG. 8) disposed to overlap the second portion 332 of the separator 330 and at least a portion of the auxiliary positive electrode tab 312, and a second binding area (e.g., a second binding area 3222 in FIG. 8) extending, for example, from the second overlap area 3221 in a third direction opposite to the second direction and not overlapping the second portion 332 of the separator 330 and the at least a portion of the auxiliary positive electrode tab 312.

According to yet another embodiment, the first binding areas 3122 attached to each of the plurality of positive electrode plates 310 may, for example, be coupled to each other by a binder coating, and the second binding areas 3222 attached to each of the plurality of negative electrode plates 320 may be coupled to each other by the binder coating.

According to still another embodiment, the first binding areas 3122 attached to each of the plurality of positive electrode plates 310 may, for example, be coupled to each other by a heat pressing process, and the second binding areas 3222 attached to each of the plurality of negative electrode plates 320 may be coupled to each other by the heat pressing process.

The first binding areas 3122 attached to each of the plurality of positive electrode plates 310 may be penetrated by at least one first via hole and coupled to each other by a process of welding the via hole, and the second binding areas 3222 attached to each of the plurality of negative electrode plates 320 may be penetrated by at least one second via hole and coupled to each other by a process of welding the via hole.

In an embodiment, the main negative electrode tab 321 has a first length in the first direction and the auxiliary negative electrode tab 322 has a second length in the first direction, in which the second length may be shorter than the first length.

In another embodiment, the main positive electrode tab 311 has a third length in the first direction and the auxiliary positive electrode tab 312 has a fourth length in the first direction, in which the fourth length may be shorter than the third length.

In yet another embodiment, the first length that the main negative electrode tab 321 has may be the same as the third length that the main positive electrode tab 311 has.

In still another embodiment, the second length that the auxiliary negative electrode tab 322 has may be the same as the fourth length that the auxiliary positive electrode tab 312 has.

An electronic device (e.g., an electronic device 101 in FIG. 1), according to various embodiments, may, for example, include a housing (not illustrated), and a flexible battery (e.g., a battery 189 in FIG. 1) disposed inside the housing, in which the flexible battery 189 may include a pouch 210, a battery assembly 220 disposed inside the pouch 210, the battery assembly 220 including a plurality of positive electrode plates 310 and a plurality of negative electrode plates 320 alternately stacked with each other, and a separator 330 disposed between the positive electrode plates 310 and the negative electrode plates 320, a main positive electrode tab 311 attached to each of the plurality of positive electrode plates 310 and protruding in a first direction of the battery assembly 220, a main negative electrode tab 321 attached to each of the plurality of negative electrode plates 320 and protruding in the first direction of the battery assembly 220, an auxiliary positive electrode tab 312 attached to each of the plurality of positive electrode plates 310, protruding in the first direction of the battery assembly 220, and disposed, for example, between the main positive electrode tab 311 and the main negative electrode tab 321, and an auxiliary negative electrode tab 322 attached to each of the plurality of negative electrode plates 320, protruding in the first direction of the battery assembly 220, and disposed between the main positive electrode tab 311 and the main negative electrode tab 321, in which the separator 330 may include a first portion 331 disposed, for example, between the positive electrode plates 310 and the negative electrode plates 320, and a second portion 332 extending from the first portion 331 in the first direction and disposed between the auxiliary positive electrode tab 312 and the auxiliary negative electrode tab 322 so as to overlap at least a portion of the auxiliary positive electrode tab 312 and at least a portion of the auxiliary negative electrode tab 322.

According to one embodiment, the auxiliary positive electrode tab 312 may include a first overlap area 3121 disposed, for example, to overlap the second portion 332 of the separator 330 and at least a portion of the auxiliary negative electrode tab 322, and a first binding area 3122 extending from the first overlap area 3121 in a second direction perpendicular to the first direction and not overlapping the second portion 332 of the separator 330 and the at least a portion of the auxiliary negative electrode tab 322.

According to another embodiment, the auxiliary negative electrode tab 322 may include a second overlap area 3221 disposed to overlap the second portion 332 of the separator 330 and at least a portion of the auxiliary positive electrode tab 312, and a second binding area 3222 extending, for example, from the second overlap area 3221 in a third direction opposite to the second direction and not overlapping the second portion 332 of the separator 330 and the at least a portion of the auxiliary positive electrode tab 312.

According to yet another embodiment, the first binding areas 3122 attached to each of the plurality of positive electrode plates 310 may be coupled to each other by a binder coating, and the second binding areas 3222 attached to each of the plurality of negative electrode plates 320 may be coupled to each other by the binder coating.

According to still another embodiment, the first binding areas 3122 attached to each of the plurality of positive electrode plates 310 may be coupled to each other by a heat pressing process, and the second binding areas 3222 attached to each of the plurality of negative electrode plates 320 may be coupled to each other by the heat pressing process.

The first binding areas 3122 attached to each of the plurality of positive electrode plates 310 may, for example, be penetrated by at least one first via hole and coupled to each other by a process of welding the via holes, and the second binding areas 3222 attached to each of the plurality of negative electrode plates 320 may be penetrated by at least one second via hole and coupled to each other by a process of welding the via holes.

In an embodiment, the main negative electrode tab 321 has a first length in the first direction and the auxiliary negative electrode tab 322 has a second length in the first direction, in which the second length may be shorter than the first length.

In another embodiment, the main positive electrode tab 311 has a third length in the first direction and the auxiliary positive electrode tab 312 has a fourth length in the first direction, in which the fourth length may be shorter than the third length.

In yet another embodiment, the first length that the main negative electrode tab 321 has may be the same as the third length that the main positive electrode tab 311 has.

In still another embodiment, the second length that the auxiliary negative electrode tab 322 has may be the same as the fourth length that the auxiliary positive electrode tab 312 has.

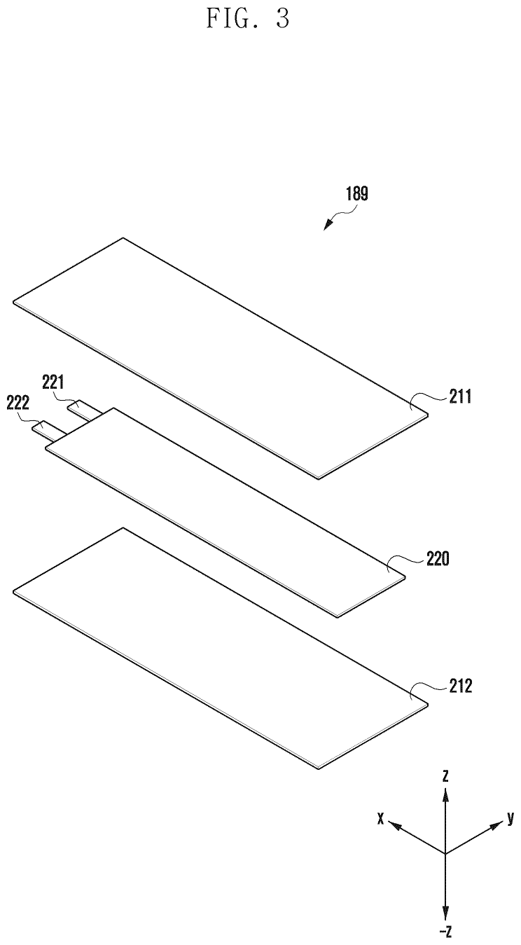

FIG. 2 is a schematic perspective view of a battery 189 according to an embodiment of the disclosure. FIG. 3 is an exploded perspective view of a battery 189 according to an embodiment of the disclosure.

A battery 189 illustrated in FIGS. 2 and 3 may include an embodiment that is at least partially similar to or different from the battery 189 illustrated in FIG. 1.

Referring to FIG. 2, a battery 189, according to various embodiments, may include a pouch 210, and a battery assembly 220 disposed in an inner space of a pouch 210.

According to an embodiment, the battery assembly 220 may include a positive electrode assembly (e.g., a positive electrode assembly 301 in FIG. 4), a separator (e.g., the separator 330 in FIG. 4), and a negative electrode assembly (e.g., a negative electrode assembly 302 in FIG. 4), which may be stacked sequentially and repeatedly with each other. In an example, the positive electrode assembly 301, the separator 330, and the negative electrode assembly 302 may be stacked to constitute a single unit assembly, and the battery assembly 220 may be formed by a plurality of unit assemblies being stacked.

According to another embodiment, the battery assembly 220 may include a positive electrode tab 221 and a negative electrode tab 222. The positive electrode tab 221 and the negative electrode tab 222 may serve as a path for current to flow when charging the battery 189 or discharging the battery 189.

According to yet another embodiment, the positive electrode tab 221 may be connected to the positive electrode assembly 301 and disposed to protrude from the battery assembly 220 in a specific direction, for example, a first direction (e.g., x-direction). The negative electrode tab 222 may be connected to the negative electrode assembly 302 and disposed to protrude from the battery assembly 220 in a specific direction, for example, the first direction (e.g., the x direction).

According to still another embodiment, at least a portion of the positive electrode tab 221 and at least a portion of the negative electrode tab 222 may be disposed to protrude outwardly from the inner space of the pouch 210. Accordingly, at least a portion of the positive electrode tab 221 and at least a portion of the negative electrode tab 222 may be visually exposed when the battery 189 is viewed from the outside.

The pouch 210 may include a front surface pouch 211 and a rear surface pouch 212. The front surface pouch 211 may be disposed to cover an upper surface of the battery assembly 220 (e.g., a surface in the z direction) and a portion of a side surface of the battery assembly 220 (e.g., a surface in the x direction and/or a surface in the y direction) extending from the upper surface. The rear surface pouch 212 may be disposed to cover a lower surface of the battery assembly 220 (e.g., a surface in the −z direction) and a portion of a side surface of the battery assembly 220 extending from the lower surface.

In an embodiment, the front surface pouch 211 and the rear surface pouch 212 may be structurally coupled at a portion adjacent to the side surface of the battery assembly 220, or may be integrally formed.

In another embodiment, the pouch 210 may be formed of a flexible material to allow the battery 189 to be flexibly bent.

In yet another embodiment, the battery assembly 220 may include an insulating film disposed on a surface opposite to the pouch 210. The insulating film may include, for example, a polymer film (e.g., a PET (polyethylene terephthalate) film). For example, the polymer film may reduce stress when the battery assembly 220 is being bent, and may allow uniform stress to be applied to an electrode body of the battery assembly 220. In another example, the polymer film may reduce stress that occurs when the battery assembly 220 is being bent being concentrated on a specific portion of the electrode body.

FIG. 4 is a perspective view schematically illustrating a battery assembly 220 according to an embodiment of the disclosure.

A battery assembly 220 illustrated in FIG. 4 may include an embodiment that is at least partially similar to or different from a battery assembly 220 illustrated in FIGS. 2 and 3.

Referring to FIG. 4, the battery assembly 220, according to various embodiments, may include the positive electrode assembly 301, the separator 330, and the negative electrode assembly 302, which may be stacked sequentially and repeatedly with each other. In an example, in the battery assembly 220, the positive electrode assembly 301, the separator 330, and the negative electrode assembly 302 may be stacked to constitute a single unit assembly, and the battery assembly 220 may be formed by a plurality of unit assemblies being stacked.

The positive electrode assembly 301 may include the positive electrode plate 310, and the main positive electrode tab 311 and the auxiliary positive electrode tab 312 that are disposed to extend from the positive electrode plate 310 in the first direction (e.g., the x-direction). For example, a single positive electrode plate 310, and the main positive electrode tab 311 and the auxiliary positive electrode tab 312 that are attached to the single positive electrode plate 310, may be defined as the “positive electrode assembly 301”.

According to another embodiment, the positive electrode plate 310 may include a positive electrode substrate, and a positive electrode active material (cathode active material) formed on one surface or both surfaces of the positive electrode substrate. For example, a mixture of a positive electrode active material, a conductive agent, and a binder (e.g., a compound) may be coated on the positive electrode substrate of the positive electrode plate 310.

According to yet another embodiment, the positive electrode plate 310 may be a metal that is formed of, for example, aluminum, stainless steel, titanium, copper, silver, or a combination of materials selected therefrom.

According to still another embodiment, the positive electrode active material may be formed of a material capable of reversibly intercalating and deintercalating lithium ions. The positive electrode active material may include at least one material selected from the group consisting of lithium transition metal oxides such as lithium cobalt oxide, lithium nickel oxide, lithium nickel cobalt oxide, lithium nickel cobalt aluminum oxide, lithium nickel cobalt manganese oxide, lithium manganese oxide, and lithium iron phosphate, nickel sulfides, copper sulfides, sulfur, iron oxides, vanadium oxides, and the like.

According to an embodiment, the conductive agent may be for increasing conductivity of the positive electrode active material. For example, the conductive agents may include at least one material selected from the group consisting of carbon-containing conducting agents such as carbon black, carbon fiber, and graphite, conductive fibers such as metal fiber, and metal powders such as carbon fluoride powder, aluminum powder, and nickel powder, conductive whiskers, such as zinc oxide and potassium titanate, conductive metal oxides, such as titanium oxide, and conductive polymers, such as polyphenylene derivatives.

According to another embodiment, the binder may serve as an adhesive to assist such that the positive electrode active material and the conductive agent on the positive electrode substrate are well coupled. The binder may, for example, include at least one material selected from the group consisting of polyvinylidene fluoride-containing binders, such as polyvinylidene fluoride, vinylidene fluoride/hexafluoropropylene copolymer, and vinylidene fluoride/tetrafluoroethylene copolymer, carboxymethyl cellulose-containing binders, such as sodium-carboxymethyl cellulose and lithium-carboxymethyl cellulose, acrylate-containing binders, such as polyacrylic acid, lithium-polyacrylic acid, acrylic, polyacrylonitrile, polymethyl methacrylate, and polybutylacrylate, polyimide-imides, polytetrafluoroethylene, polyethylene oxide, polypyrrole, lithium-Nafion, and styrene butadiene rubber-containing polymers.

According to yet another embodiment, the main positive electrode tab 311 and the auxiliary positive electrode tab 312 may extend from a portion of the positive electrode substrate in the first direction (e.g., in the x direction). The main positive electrode tab 311 and the auxiliary positive electrode tab 312 may be disposed to be spaced apart at a specified interval.

According to still another embodiment, the negative electrode assembly 302 may include the negative electrode plate 320, and the main negative electrode tab 321 and the auxiliary negative electrode tab 322 that are disposed to extend from the negative electrode plate 320 in the first direction (e.g., the x-direction). In an example, a single negative electrode plate 320, and the main negative electrode tab 321 and the auxiliary negative electrode tab 322 that are attached to the single negative electrode plate 320, may be defined as the “negative electrode assembly 302”.

The negative electrode plate 320 may include a negative electrode substrate, and a negative electrode active material (anode active material) formed on one surface or both surfaces of the negative electrode substrate. For example, a mixture of a negative electrode active material, a conductive agent, and a binder (e.g., a compound) may be coated on the negative electrode substrate of the negative electrode plate 320.

According to one embodiment, the negative electrode plate 320 may include at least one metal selected from the group consisting of, for example, copper, stainless steel, nickel, aluminum, and titanium.

According to another embodiment, the negative electrode active material may be formed of a material capable of forming an alloy together with lithium or a material capable of reversibly intercalating and deintercalating lithium.

According to yet another embodiment, the negative electrode active material may include at least one of carbon, silicon, and graphite. According to an embodiment, the negative electrode active material may be formed of a material capable of forming an alloy together with lithium or a material capable of reversibly intercalating and deintercalating lithium. The negative electrode active material may include at least one material selected from the group consisting of metals, carbon-containing materials, metal oxides, and lithium metal nitrides.

In an example, the metals of the negative electrode active material may include at least one material selected from the group consisting of lithium, silicon, magnesium, calcium, aluminum, germanium, tin, lead, arsenic, antimony, bismuth, silver, gold, zinc, cadmium, mercury, copper, iron, nickel, cobalt, and indium.

In another example, the carbon-containing materials of the negative electrode active material may include at least one material selected from the group consisting of graphite, graphite carbon fiber, coke, mesocarbon microbeads (MCMBS), polyacene, pitch-derived carbon fiber, and hard carbon.

In yet another example, the metal oxides of the negative electrode active material may include at least one selected from the group consisting of lithium titanium oxides, titanium oxides, molybdenum oxides, niobium oxides, iron oxides, tungsten oxides, tin oxides, amorphous tin oxide composites, silicon monoxide, cobalt oxides, and nickel oxides.

In an embodiment, the conductive agent may be for increasing conductivity of the negative electrode active material. In another embodiment, the binder may serve as an adhesive to assist such that the negative electrode active material and the conductive agent on the negative electrode substrate are well coupled. According to an embodiment, the binder and the conductive agent may be the same as or similar to the binder and the conductive agent applied to the positive electrode plate 310.

According to yet another embodiment, the main negative electrode tab 321 and the auxiliary negative electrode tab 322 may extend from a portion of the negative electrode substrate in the first direction (e.g., in the x direction). In still another embodiment, the main negative electrode tab 321 and the auxiliary negative electrode tab 322 may be disposed to be spaced apart from each other.

The separator 330 may be disposed between the positive electrode assembly 301 and the negative electrode assembly 302 to insulate the positive electrode assembly 301 and the negative electrode assembly 302 from each other. For example, the separator 330 may be disposed between the positive electrode plate 310 of the positive electrode assembly 301 and the negative electrode plate 320 of the negative electrode assembly 302 to insulate the positive electrode plate 310 and the negative electrode plate 320 from each other.

According to another embodiment, the separator 330 may be formed of a porous polymeric membrane, such as, for example, a polyethylene membrane or a polypropylene membrane. The separator 330 may include the second portion 332 extending in the first direction (e.g., in the x direction) to insulate the auxiliary positive electrode tab 312 of the positive electrode assembly 301 and the auxiliary negative electrode tab 322 of the negative electrode assembly 302 from each other. For example, the second portion 332 of the separator 330 may insulate at least a portion of the auxiliary positive electrode tab 312 and at least a portion of the auxiliary negative electrode tab 322 from each other.

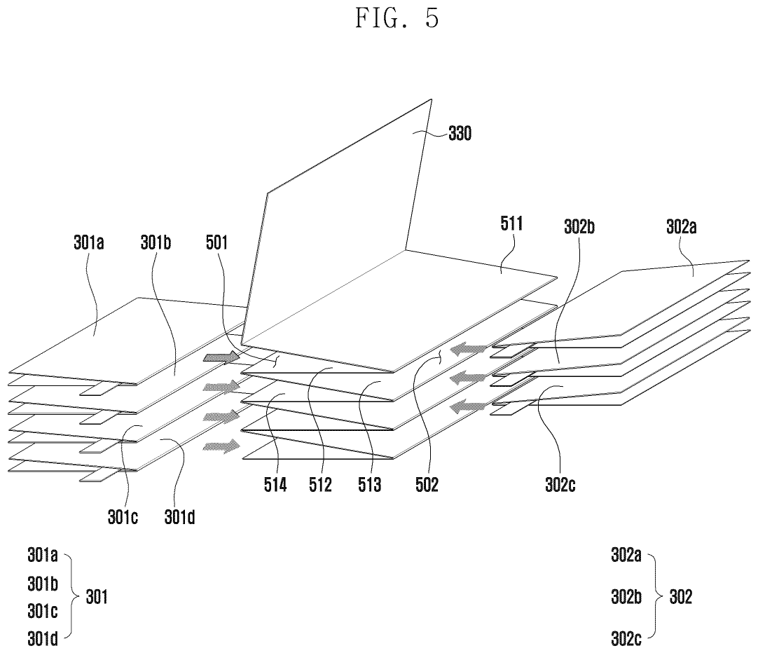

FIG. 5 is a stacked perspective view schematically illustrating a method of stacking a battery assembly 220 according to an embodiment of the disclosure.

A battery assembly 220 illustrated in FIG. 5 may include an embodiment that is at least partially similar to or different from a battery assembly 220 illustrated in FIGS. 2 to 4.

Referring to FIG. 5, the battery assembly 220 according to various embodiments may have the separator 330 disposed in a multi-folding method. In an example, the separator 330 may be stacked by folding multiple times, similar to a folding screen, and may have sub-areas of the separator 330 with a specified width and a specified area so that the sub-areas face each other by folding. In another example, as the separator 330 is stacked in the multi-folding method, the sub-areas of the separator 330 (e.g., a first sub-area 511, a second sub-area 512, and a third sub-area 513) may have the same area. The “multi-folding method” may be a method of folding the separator 330 multiple times in a zigzag manner, such that folding areas are disposed alternately on each of one side and the other side of the sub-areas (e.g., the first sub-area 511, the second sub-area 512, and the third sub-area 513) of the separator 330.

Each of the plurality of positive electrode assemblies 301 may be inserted into an odd numbered space (e.g., a first space 501) formed by the separator 330 stacked in the multi-folding method and disposed in the odd numbered space (e.g., the first space 501). For example, a first positive electrode assembly 301a of the plurality of positive electrode assemblies 301a, 301b, 301c, and 301d may be disposed between the first sub-area 511 of the separator 330 and the second sub-area 512 of the separator 330 that is disposed to face the first sub-area 511 underneath the first sub-area 511 to form an odd numbered space (e.g., the first space 501).

According to another embodiment, each of the plurality of negative electrode assemblies 302 may be inserted into an even numbered space (e.g., a second space 502) formed by the separator 330 stacked in the multi-folding method and disposed in the even numbered space (e.g., a second space 502). In an example, a first negative electrode assembly 302a of the negative electrode assemblies 302a, 302b, and 302c may be disposed between the second sub-area 512 of the separator 330 and the third sub-area 513 of the separator 330 that is disposed to face the second sub-area 512 underneath the second sub-area 512 to form an even numbered space (e.g., the second space 502).

According to still another embodiment, a second positive electrode assembly 301b of the plurality of positive electrode assemblies 301a, 301b, 301c, and 301d may be disposed between the third sub-area 513 of the separator 330 and the fourth sub-area 514 of the separator 330 that is disposed to face the third sub-area 513 underneath the third sub-area 513 to form an odd numbered space.

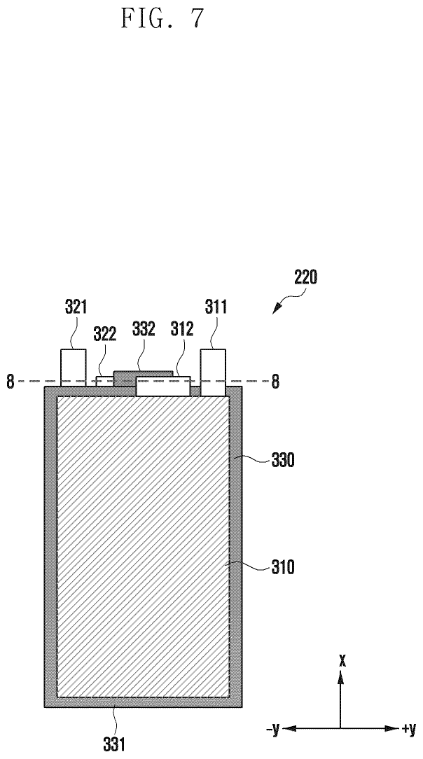

FIG. 6 is a top plan view schematically illustrating structures of a positive electrode assembly 301, a separator 330, and a negative electrode assembly 302, according to an embodiment of the disclosure. FIG. 7 is a top plan view illustrating a state in which a positive electrode assembly 301, a separator 330, and a negative electrode assembly 302 are stacked, according to an embodiment of the disclosure.

The positive electrode assembly 301, the separator 330, and the negative electrode assembly 302 illustrated in FIGS. 6 and 7 may, for example, include an embodiment that is at least partially similar to or different from the positive electrode assembly 301, the separator 330, and the negative electrode assembly 302 illustrated in FIGS. 2 to 5.

Referring to FIGS. 6 and 7, an area of the separator 330 according to an embodiment may be larger than an area of the positive electrode plate 310, and/or larger than an area of the negative electrode plate 320. According to one embodiment, the area of the positive electrode plate 310 may be substantially equal to the area of the negative electrode plate 320. The area of the positive electrode plate 310 may be different from the area of the negative electrode plate 320.

Referring to FIGS. 6 and 7, the battery assembly 220, according to various embodiments, may include the positive electrode assembly 301, the separator 330, and the negative electrode assembly 302.

The positive electrode assembly 301 may include the positive electrode plate 310, and the main positive electrode tab 311 and the auxiliary positive electrode tab 312 that are disposed to extend from the positive electrode plate 310 in the first direction (e.g., the x-direction). According to another embodiment, the positive electrode plate 310 may include a positive electrode substrate, and a positive electrode active material (cathode active material) formed on one surface or both surfaces of the positive electrode substrate.

According to yet another embodiment, the main positive electrode tab 311 and the auxiliary positive electrode tab 312 may extend from a portion of the positive electrode substrate in the first direction (e.g., in the x direction). The main positive electrode tab 311 and the auxiliary positive electrode tab 312 may be disposed to be spaced apart from each other.

According to still another embodiment, the negative electrode assembly 302 may include the negative electrode plate 320, and the main negative electrode tab 321 and the auxiliary negative electrode tab 322 that are disposed to extend from the negative electrode plate 320 in the first direction (e.g., the x-direction). The negative electrode plate 320 may include a negative electrode substrate, and a negative electrode active material (anode active material) formed on one surface or both surfaces of the negative electrode substrate.

The main negative electrode tab 321 and the auxiliary negative electrode tab 322 may extend from a portion of the negative electrode substrate in the first direction (e.g., in the x direction). According to an embodiment, the main negative electrode tab 321 and the auxiliary negative electrode tab 322 may be disposed to be spaced apart from each other.

At least a portion of the auxiliary negative electrode tab 322 and at least a portion of the auxiliary positive electrode tab 312 are disposed to overlap each other, and an extension portion of the separator 330 (e.g., the second portion 332 of the separator 330) may be disposed therebetween.

The separator 330 may include a first portion 331 disposed, for example, between the positive electrode plate 310 and the negative electrode plate 320 to insulate the positive electrode plate 310 and the negative electrode plate 320 from each other, and a second portion 332 extending from the first portion 331 in the first direction (e.g., in the x direction) and disposed between at least a portion of the auxiliary negative electrode tab 322 and at least a portion of the auxiliary positive electrode tab 312.

The main negative electrode tab 321 has a first length L1 in the first direction (e.g., in the x direction), and the auxiliary negative electrode tab 322 has a second length L2 in the first direction (e.g., in the x direction), in which the second length L2 may be shorter than the first length L1.

The main positive electrode tab 311 has a third length L3 in the first direction (e.g., in the x direction) and the auxiliary positive electrode tab 312 has a fourth length L4 in the first direction (e.g., in the x direction), in which the fourth length L4 may be shorter than the third length L3.

According to one embodiment, the first length L1 of the main negative electrode tab 321 may be the same as the third length L3 of the main positive electrode tab 311.

According to another embodiment, the second length L2 of the auxiliary negative electrode tab 322 may be the same as the fourth length L4 of the auxiliary positive electrode tab 312.

According to yet another embodiment, the second portion 332 of the separator 330 has a fifth length L5, in which the fifth length L5 may be longer than the second length L2 that the auxiliary negative electrode tab 322 has and the fourth length L4 that the auxiliary positive electrode tab 312 has.

According to various embodiments, a length of the negative electrode assembly 302 that includes the negative electrode plate 320 and the auxiliary negative electrode tab 322 may have a sixth length L6. A length of the positive electrode assembly 301 that includes the positive electrode plate 310 and the auxiliary positive electrode tab 312 may have a seventh length L7. A length of the separator 330 that includes the first portion 331 and the second portion 332 may have an eighth length L8. According to some embodiments, the eighth length L8 of the separator 330 that includes the first portion 331 and the second portion 332 may be longer than the sixth length L6 of the negative electrode assembly 302 that includes the negative electrode plate 320 and the auxiliary negative electrode tab 322. According to other embodiments, the eighth length L8 of the separator 330 that includes the first portion 331 and the second portion 332 may be longer than the seventh length L7 of the positive electrode assembly 301 that includes the positive electrode plate 310 and the auxiliary positive electrode tab 312.

FIG. 8 is a cross-sectional view illustrating a structure of an auxiliary positive electrode tab 312, an auxiliary negative electrode tab 322, and an second portion 332 of a separator 330 according to lines 8-8 illustrated in FIG. 7 according to an embodiment of the disclosure.

The auxiliary positive electrode tab 312, the auxiliary negative electrode tab 322, and the second portion 332 of the separator 330 illustrated in FIG. 8 may, for example, include an embodiment that is at least partially similar to or different from the auxiliary positive electrode tab 312, the auxiliary negative electrode tab 322, and the second portion 332 of the separator 330 illustrated in FIGS. 4 to 7.

In an embodiment, as the battery assembly 220 includes a structure in which the plurality of negative electrode assemblies 302 and the plurality of positive electrode assemblies 301 are stacked, the battery assembly 220 may include the plurality of main negative electrode tabs 321, the plurality of auxiliary negative electrode tabs 322, the plurality of main positive electrode tabs 311, and the plurality of auxiliary positive electrode tabs 312, which may be disposed to extend from the battery assembly 220 in the first direction (e.g., in the x direction).

In another embodiment, the main positive electrode tab 311 and the auxiliary positive electrode tab 312 may be disposed to be spaced apart from each other. For example, the main positive electrode tab 311 may be disposed in the second direction (e.g., in the +y direction) perpendicular to the first direction (e.g., in the x direction) from the auxiliary positive electrode tab 312.

In yet another embodiment, at least a portion of the auxiliary positive electrode tab 312 may include the first overlap area 3121 and the first binding area 3122 as the at least a portion of the auxiliary positive electrode tab 312 is disposed to overlap the auxiliary negative electrode tab 322 and the second portion 332 of the separator 330.

In still another embodiment, the first overlap area 3121 of the auxiliary positive electrode tab 312 may be an area that overlaps the second portion 332 of the separator 330 and at least a portion of the auxiliary negative electrode tab 322.

The first binding area 3122 of the auxiliary positive electrode tab 312 may be an area that extends in the second direction (e.g., in the +y direction) from the first overlap area 3121 and does not overlap the second portion 332 of the separator 330 and at least a portion of the auxiliary negative electrode tab 322.

According to an embodiment, a plurality of first binding areas 3122 may be electrically connected to the positive electrode tab 221 of the battery assembly 220 together with the main positive electrode tab 311 by being engaged and fixed by a binding member (e.g., a binding member 1010 in FIG. 10), as described below with reference to FIG. 10. In an example, a path electrically connecting the positive electrode tab 221 that is visually exposed when the battery 189 is viewed from the outside to the positive electrode assembly 301 disposed inside the pouch 210 may be formed to be bypassed not only by the main positive electrode tab 311, but also by the auxiliary positive electrode tab 312. Even if the main positive electrode tab 311 is damaged by the battery 189 being flexibly bent, the path electrically connecting the positive electrode tab 221 to the positive electrode assembly 301 disposed inside the pouch 210 may be formed to be bypassed also by the auxiliary positive electrode tab 312, thereby increasing reliability of the battery 189.

The main negative electrode tab 321 and the auxiliary negative electrode tab 322 may be disposed to be spaced apart from each other. In an example, the main negative electrode tab 321 may be disposed in the third direction (e.g., in the −y direction) that is perpendicular to the first direction (e.g., the x direction) and opposite the second direction (e.g., the +y direction) from the auxiliary negative electrode tab 322.

At least a portion of the auxiliary negative electrode tab 322 may include the second overlap area 3221 and the second binding area 3222 as the at least a portion of the auxiliary negative electrode tab 322 is disposed to overlap the auxiliary positive electrode tab 312 and the second portion 332 of the separator 330.

The second overlap area 3221 of the auxiliary negative electrode tab 322 may be an area that overlaps the second portion 332 of the separator 330 and at least a portion of the auxiliary positive electrode tab 312.

The second binding area 3222 of the auxiliary negative electrode tab 322 may be an area that extends in the third direction (e.g., in the −y direction) from the second overlap area 3221 and does not overlap the second portion 332 of the separator 330 and at least a portion of the auxiliary positive electrode tab 312.

A plurality of second binding areas 3222 may be electrically connected to the negative electrode tab 222 of the battery assembly 220 together with the main negative electrode tab 321 by being engaged and fixed by a binding member (e.g., the binding member 1010 in FIG. 10), as described below with reference to FIG. 10. For example, a path electrically connecting the negative electrode tab 222 that is visually exposed when the battery 189 is viewed from the outside to the negative electrode assembly 302 disposed inside the pouch 210 may be formed to be bypassed not only by the main negative electrode tab 321, but also by the auxiliary negative electrode tab 322. Even if the main negative electrode tab 321 is damaged by the battery 189 being flexibly bent, the path electrically connecting the negative electrode tab 222 to the negative electrode assembly 302 disposed inside the pouch 210 may be formed to be bypassed also by the auxiliary negative electrode tab 322, thereby increasing reliability of the battery 189.

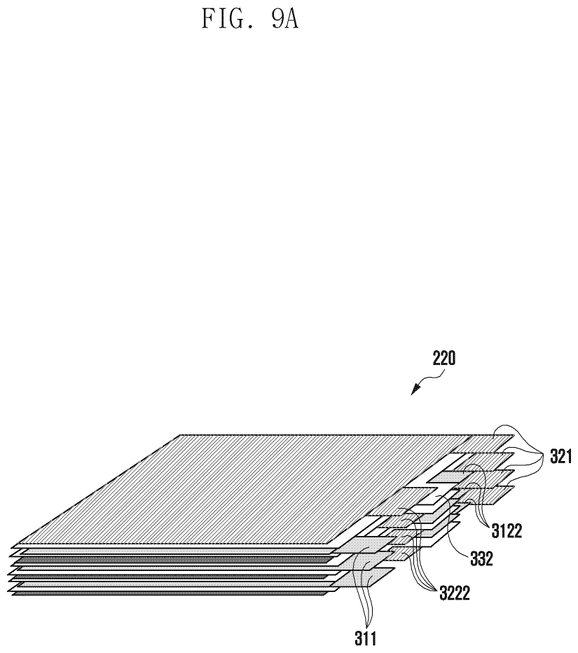

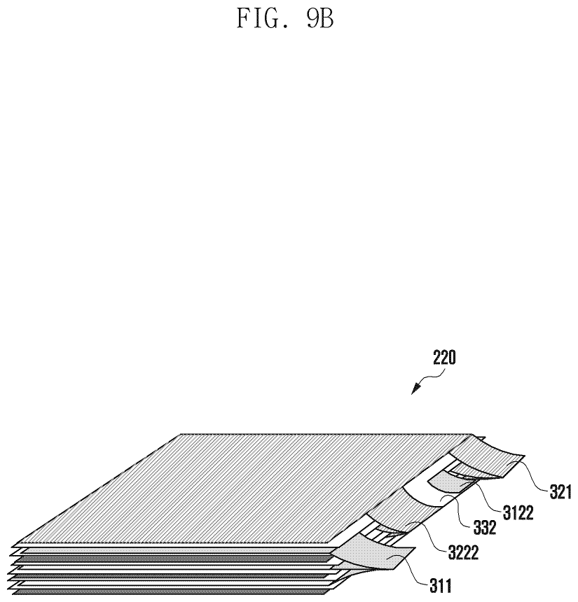

FIGS. 9A and 9B are perspective views of a battery assembly 220 for describing a connection of a positive electrode tab 221 and a connection of a negative electrode tab 222, according to various embodiments of the disclosure.

In an example, FIG. 9A is a view illustrating a state before proceeding with a process for connecting the positive electrode tab 221 and connecting the negative electrode tab 222, and FIG. 9B is a view illustrating a state before proceeding with a process for connecting the positive electrode tab 221 and connecting the negative electrode tab 222.

The auxiliary positive electrode tab 312, the auxiliary negative electrode tab 322, and the second portion 332 of the separator 330 illustrated in FIGS. 9A and 9B may include an embodiment that is at least partially similar to or different from the auxiliary positive electrode tab 312, the auxiliary negative electrode tab 322, and the second portion 332 of the separator 330 illustrated in FIGS. 4 to 8.

Referring to FIGS. 9A and 9B, a binding structure of the battery 189 according to various embodiments will be described.

According to one embodiment, the plurality of first binding areas 3122 attached to each of the plurality of positive electrode plates 310 may be coupled to each other by a binder coating or tape. The plurality of second binding areas 3222 attached to each of the plurality of negative electrode plates 320 may be coupled to each other by the binder coating or tape.

According to another embodiment, the plurality of first binding areas 3122 attached to each of the plurality of positive electrode plates 310 may be coupled to each other by a heat pressing process. The plurality of second binding areas 3222 attached to each of the plurality of negative electrode plates 320 may be coupled to each other by the heat pressing process.

According to yet another embodiment, the plurality of first binding areas 3122 attached to each of the plurality of positive electrode plates 310 may be penetrated by at least one first via hole (not illustrated) and coupled to each other by a process of welding the first via hole. The plurality of second binding areas 3222 attached to each of the plurality of negative electrode plates 320 are penetrated by at least one second via hole (not illustrated) and may, for example, be coupled to each other by a process of welding the second via hole.

In a general battery that does not have elasticity, the main positive electrode tab 311 and/or the main negative electrode tab 321 of the battery assembly 220 that is connected to the positive electrode tab 221 and the negative electrode tab 222 may serve as a path through which current flows. In contrast, in case of the flexible battery 189, the main positive electrode tab 311 and/or the main negative electrode tab 321 of the battery assembly 220 not only serve as a path through which current flows, but also serve to maintain or fix the entire shape of the battery assembly 220 when the flexible battery 189 is being bent, and may be used as a reference for restoration when the flexible battery 189 is restored to an original state after being bent. The flexible battery 189 may experience a failure in which the main positive electrode tab 311 and/or the main negative electrode tab 321 is disconnected due to stress when repeatedly being bent. When the failure in which the main positive electrode tab 311 and/or the main negative electrode tab 321 is disconnected occurs, problems such as reduced output or capacity of the battery 189, reduced runtime of the battery 189, or poor charging may occur.

According to some embodiments, in the battery assembly 220, the auxiliary positive electrode tab 312 and the auxiliary negative electrode tab 322 are additionally formed in addition to the main positive electrode tab 311 and the main negative electrode tab 321, and an extension portion of the separator 330 (e.g., a second portion 332 of a separator 330) is disposed between the auxiliary positive electrode tab 312 and the auxiliary negative electrode tab 322 that are additionally formed, so that the auxiliary positive electrode tab 312 and the auxiliary negative electrode tab 322 may be insulated from each other.

In the battery assembly 220, according to other embodiments, at least a portion of the auxiliary positive electrode tab 312 (e.g., the first binding area 3122) is designed to not overlap the extension portion of the separator 330 (e.g., a second portion 332 of a separator 330), and the first binding areas 3122 of the auxiliary positive electrode tabs 312 may be engaged and/or fixed to each other so that an electrical path (not illustrated) may be formed that is connected to a positive electrode tab (e.g., the positive electrode tab 221 in FIG. 2) together with the main positive electrode tab 311.

In the battery assembly 220, according to various embodiments, at least a portion of the auxiliary negative electrode tab 322 (e.g., a second binding area 3222) is designed to not overlap the extension portion of the separator 330 (e.g., a second portion 332 of the separator 330), and the second binding areas 3222 of the auxiliary negative electrode tabs 322 may be engaged and/or fixed to each other so that an electrical path (not illustrated) may be formed that is connected to a negative electrode tab (e.g., the negative electrode tab 222 in FIG. 2) together with the main negative electrode tab 321.

The flexible battery 189 and an electronic device including the same (e.g., an electronic device 101 in FIG. 1), according to various embodiments of the disclosure, may increase reliability by having a design structure that is robust enough to reduce damage to electrode portions of the battery 189 even when repeatedly bent, and may reduce factors for safety accidents of the battery 189, such as poor charging, heat generation, or ignition.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A flexible battery comprising:
a pouch;
a battery assembly disposed inside the pouch, the battery assembly comprising:
a plurality of positive electrode plates and a plurality of negative electrode plates stacked alternately with each other, and
a separator disposed in between the positive electrode plates and the negative electrode plates;
a main positive electrode tab attached to each of the plurality of positive electrode plates and protruding in a first direction of the battery assembly;
a main negative electrode tab attached to each of the plurality of negative electrode plates and protruding in the first direction of the battery assembly;
an auxiliary positive electrode tab attached to each of the plurality of positive electrode plates, protruding in the first direction of the battery assembly, and disposed in between the main positive electrode tab and the main negative electrode tab; and
an auxiliary negative electrode tab attached to each of the plurality of negative electrode plates, protruding in the first direction of the battery assembly, and disposed in between the main positive electrode tab and the main negative electrode tab,
wherein the separator comprises:
a first portion disposed in between the positive electrode plates and the negative electrode plates, and
a second portion extending in the first direction from the first portion, and disposed in between the auxiliary positive electrode tab and the auxiliary negative electrode tab so as to overlap at least a portion of the auxiliary positive electrode tab and at least a portion of the auxiliary negative electrode tab.

2. The flexible battery of claim 1, wherein the auxiliary positive electrode tab comprises:
a first overlap area disposed to overlap the second portion of the separator and at least a portion of the auxiliary negative electrode tab, and
a first binding area extending from the first overlap area in a second direction perpendicular to the first direction and not overlapping the second portion of the separator and the at least a portion of the auxiliary negative electrode tab.

3. The flexible battery of claim 2, wherein the auxiliary negative electrode tab comprises:
a second overlap area disposed to overlap the second portion of the separator and at least a portion of the auxiliary positive electrode tab, and
a second binding area extending from the second overlap area in a third direction opposite to the second direction and not overlapping the second portion of the separator and the at least a portion of the auxiliary positive electrode tab.

4. The flexible battery of claim 3,
wherein first binding areas attached to each of the plurality of positive electrode plates are coupled to each other by a binder coating, and
wherein second binding areas attached to each of the plurality of negative electrode plates are coupled to each other by the binder coating.

5. The flexible battery of claim 3,
wherein first binding areas attached to each of the plurality of positive electrode plates are coupled to each other by a heat pressing process, and
wherein second binding areas attached to each of the plurality of negative electrode plates are coupled to each other by the heat pressing process.

6. The flexible battery of claim 3,
wherein first binding areas attached to each of the plurality of positive electrode plates are penetrated by at least one first via hole and coupled to each other by a process of welding the first via holes, and
wherein second binding areas attached to each of the plurality of negative electrode plates are penetrated by at least one second via hole and coupled to each other by a process of welding the second via holes.

7. The flexible battery of claim 1,
wherein the main negative electrode tab has a first length in the first direction and the auxiliary negative electrode tab has a second length in the first direction, and
wherein the second length is shorter than the first length.

8. The flexible battery of claim 7,
wherein the main positive electrode tab has a third length in the first direction and the auxiliary positive electrode tab has a fourth length in the first direction, and
wherein the fourth length is shorter than the third length.

9. The flexible battery of claim 8, wherein the first length that the main negative electrode tab has is substantially equal to the third length that the main positive electrode tab has.

10. The flexible battery of claim 8, wherein the second length that the auxiliary negative electrode tab has is substantially equal to the fourth length that the auxiliary positive electrode tab has.

11. An electronic device comprising:
a housing; and
a flexible battery disposed inside the housing,
wherein the flexible battery comprises:
a pouch,
a battery assembly disposed inside the pouch, the battery assembly comprising a plurality of positive electrode plates and a plurality of negative electrode plates stacked alternately with each other, and a separator disposed in between the positive electrode plates and the negative electrode plates,
a main positive electrode tab attached to each of the plurality of positive electrode plates and protruding in a first direction of the battery assembly,
a main negative electrode tab attached to each of the plurality of negative electrode plates and protruding in the first direction of the battery assembly,
an auxiliary positive electrode tab attached to each of the plurality of positive electrode plates, protruding in the first direction of the battery assembly, and disposed in between the main positive electrode tab and the main negative electrode tab, and
an auxiliary negative electrode tab attached to each of the plurality of negative electrode plates, protruding in the first direction of the battery assembly, and disposed in between the main positive electrode tab and the main negative electrode tab, and
wherein the separator comprises:
a first portion disposed in between the positive electrode plates and the negative electrode plates, and
a second portion extending in the first direction from the first portion, and disposed in between the auxiliary positive electrode tab and the auxiliary negative electrode tab so as to overlap at least a portion of the auxiliary positive electrode tab and at least a portion of the auxiliary negative electrode tab.

12. The electronic device of claim 11, wherein the auxiliary positive electrode tab comprises:
a first overlap area disposed to overlap the second portion of the separator and at least a portion of the auxiliary negative electrode tab, and
a first binding area extending from the first overlap area in a second direction perpendicular to the first direction and not overlapping the second portion of the separator and the at least a portion of the auxiliary negative electrode tab.

13. The electronic device of claim 12, wherein the auxiliary negative electrode tab comprises:
a second overlap area disposed to overlap the second portion of the separator and at least a portion of the auxiliary positive electrode tab, and
a second binding area extending from the second overlap area in a third direction opposite to the second direction and not overlapping the second portion of the separator and the at least a portion of the auxiliary positive electrode tab.

14. The electronic device of claim 13,
wherein first binding areas attached to each of the plurality of positive electrode plates are coupled to each other by a binder coating, and
wherein second binding areas attached to each of the plurality of negative electrode plates are coupled to each other by the binder coating.

15. The electronic device of claim 13,
wherein first binding areas attached to each of the plurality of positive electrode plates are coupled to each other by a heat pressing process, and
wherein second binding areas attached to each of the plurality of negative electrode plates are coupled to each other by the heat pressing process.
